(19) United States
(12) Patent Application Publication
(10) Pub. No.: US 2005/0094312 A1
(43) Pub. Date: May 5, 2005

(54) Disk drive and electronic device provided with the same

(75) Inventor: Toshikuni Sato, Fussa-shi (JP)

Correspondence Address: FOLEY & LARDNER, 2029 CENTURY PARK EAST, SUITE 3500, LOS ANGELES, CA, 90067, US

(73) Assignee: KABUSHIKI KAISHA TOSHIBA

(21) Appl. No.: 10/885,473

(22) Filed: Jul. 1, 2004

(30) Foreign Application Priority Data
Oct. 31, 2003 (JP) 2003-373625

(51) Int. Cl. G11B 17/00

(52) U.S. Cl. 360/97.01

(57) ABSTRACT

An HDD includes a first shell and a second shell which is opposed to the first shell and constitutes a casing in conjunction with the first shell. The first shell is fitted with a spindle motor, which supports an information recording medium. The second shell is fitted with a head actuator, which supports a head for movement and moves the head with respect to the information recording medium. Control circuitry controls the head actuator and has a first portion, attached to the second shell and connected to the head actuator and at least one second portion located on at least one of the first and second shells and connected to the first portion.

### CROSS-REFERENCE TO RELATED APPLICATIONS

This application is based upon and claims the benefit of priority from the prior Japanese Patent Application No. 2003-373625, filed Oct. 31, 2003, the entire contents of which are incorporated herein by reference.

### BACKGROUND OF THE INVENTION

This invention relates to a disk drive having a disk for use as a recording medium and an electronic device provided with the same.

In recent years, disk drives, such as magnetic disk drives, optical disk drives, etc., have been widely used as external recording devices or image recording devices for computers.

A magnetic disk drive, as a disk drive, generally comprises a casing and a top cover. The casing is an open-topped rectangular box. The top cover is fixed to the casing with screws and closes a top opening of the casing. The casing houses a magnetic disk, spindle motor, magnetic heads, head actuator, voice coil motor, board unit, etc. The magnetic disk serves as a magnetic recording medium. The spindle motor serves as drive means that supports and rotates the magnetic disk. The magnetic heads write information to and read it from the disk. The head actuator supports the magnetic heads for movement with respect to the magnetic disk. The voice coil motor rocks and positions the head actuator. The board unit has a head IC and the like.

A printed circuit board which controls the operations of the spindle motor, voice coil motor, and magnetic heads is screwed to the outer surface of the bottom wall of the casing with the board unit between them. An interface (I/F) connector for connecting the magnetic disk drive to an external device is soldered to an end portion of the printed circuit board.

Described in Jpn. Pat. Appln. KOKAI Publication No. 2001-210058 is a magnetic disk drive that has the form of a thin card and can be loaded into a card slot of a personal computer, for example. The card-shaped magnetic disk drive of this type must be made thinner and smaller than a conventional one. To meet this requirement, various components are mounted on a plate-shaped base, a support frame is fixed on the peripheral edge of the base, and a plate-shaped top cover is attached to the support frame. Further, a printed circuit board is located on the backside of the base, and an I/F connector on the circuit board is positioned and held by means of a dedicated fixing member on the support frame.

Further miniaturization of magnetic disk drives these days is being promoted so that they can be used as recording units for a wider variety of electronic devices, especially for smaller-sized electronic devices. If one such disk drive is reduced in size, however, its basic components cannot be reduced in number. It is difficult, therefore, to secure good spaces for setting and assembling the components on a small-sized base. With the miniaturization of the magnetic disk drives, moreover, the components including the head actuator are reduced in size, and it becomes harder to assemble the various components on the base.

### BRIEF SUMMARY OF THE INVENTION

A disk drive according to an aspect of the invention comprises: a first shell and a second shell which is opposed to the first shell and constitutes a casing in conjunction with the first shell; a drive motor located on the first shell and a disk-shaped information recording medium which is supported and rotated by the drive motor; a head which processes information for the information recording medium; a head actuator which is attached to the second shell, supports the head for movement, and moves the head with respect to the information recording medium; a board unit (a first part of control circuitry) attached to the second shell and connected to the head actuator; and a control circuit board (a second part of the control circuitry) secured to an outer surface of the casing and connected to the board unit.

An electronic device according to another aspect of the invention comprises a device body and a disk drive according to claim 1, located in the device body.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a hard disk drive (hereinafter referred as an HDD) according to a first embodiment of the invention;

FIG. 2 is an exploded perspective view of the HDD;

FIG. 3 is an exploded perspective view showing a casing and the internal structure of the HDD;

FIG. 4 is a plan view showing the internal structure of the HDD with its second shell off;

FIG. 5 is a sectional view of the HDD taken along line V-V of FIG. 4;

FIG. 6 is a perspective view showing a portable telephone provided with the portable telephone;

FIG. 7 is a perspective view showing an HDD according to a second embodiment of the invention;

FIG. 8 is a perspective view showing a modification of a control circuit board of the second embodiment;

FIG. 9 is a perspective view showing another modification of the control circuit board of the second embodiment;

FIG. 10 is a perspective view showing an HDD according to a third embodiment of the invention;

FIG. 11 is an exploded perspective view showing the HDD according to the third embodiment; and

FIG. 12 is a plan view showing an HDD according to a fourth embodiment of the invention.

### DETAILED DESCRIPTION OF THE INVENTION

HDDs according to embodiments of this invention will now be described in detail with reference to the accompanying drawings.

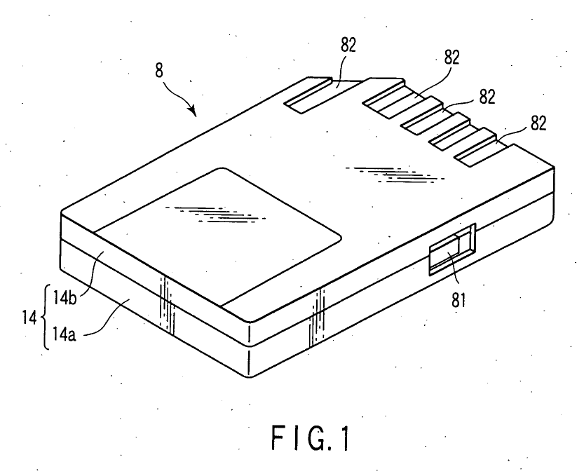

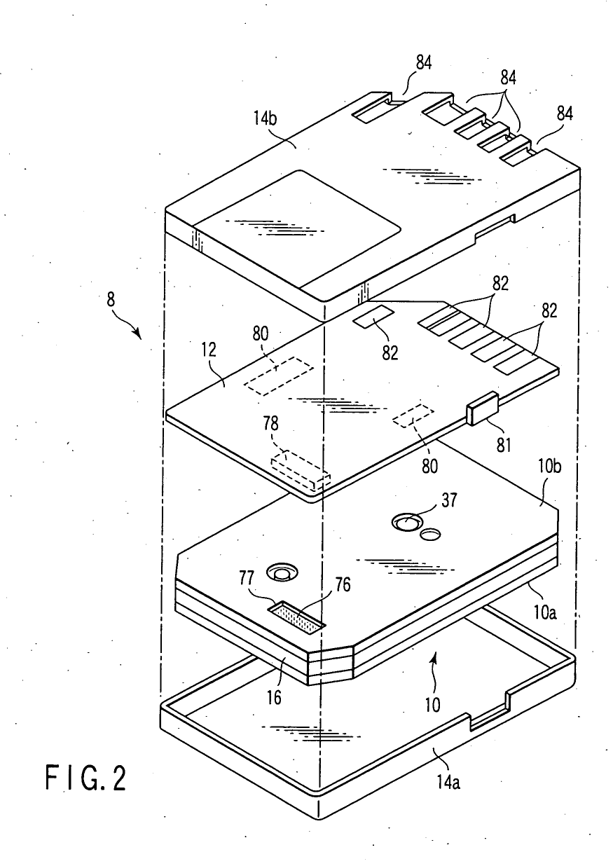

As shown in FIGS. 1 and 2, an HDD 8 is formed in a shape of a portable card about 32 mm long, 24 mm wide, and 5 mm or 3.3 mm thick. The HDD comprises a casing 10, a control circuit board 12, and a cover 14. The casing 10 is a substantially rectangular box that houses various members, which will be mentioned later. The circuit board 12 is put on the outer surface of the casing 10. The cover 14 encloses the casing and the control circuit board.

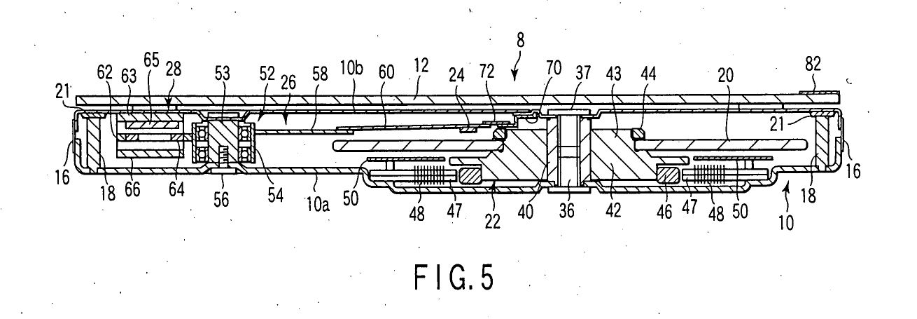

As shown in FIGS. 2 to 5, the casing 10 that constitutes the body of the HDD includes first and second shells 10a and 10b, which have substantially equal dimensions. The shells 10a and 10b are substantially rectangular metallic structures having sidewalls on their respective peripheral edge portions. The first and second shells 10a and 10b are arranged to face each other and their peripheral edge portions are opposed to each other with a gap between them. A belt-shaped sealing member 16 is wound around the peripheral edge portions of the shells 10a and 10b so that the peripheral edge portions are connected to each other and the gap between them is sealed.

Support posts 18 are arranged on the peripheral edge portion of the inside of the casing 10. Each post 18 has a proximal end that is fixed to the inner surface of the second shell 10b across an elastic member 21 of, e.g., rubber. It is set up almost square to the inner surface of the shell 10b. An extended end of each support post 18 engages the first shell 10a. The first and second shells 10a and 10b are supported by the posts 18 and opposed to each other with a gap between them.

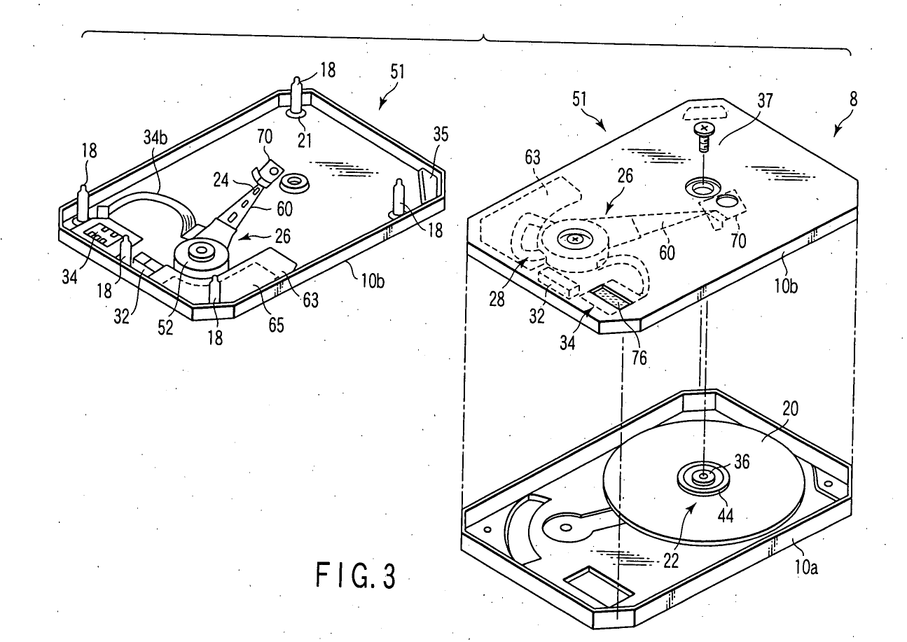

As shown in FIGS. 3 to 5, the casing 10 houses a magnetic disk 20, spindle motor 22, magnetic head 24, carriage 26, voice coil motor (hereinafter referred to as a VCM) 28, ramp load mechanism 30, electromagnetic latch 32, board unit 34, and pack-shaped air filter 35. The magnetic disk 20 has a diameter of, e.g., 0.85 inches and serves as an information recording medium. The spindle motor 22 serves as a drive motor that supports and rotates the magnetic disk. The magnetic head 24 writes information in and reads it from the disk. The carriage 26 supports the magnetic head 24 for movement with respect to the magnetic disk 20. The VCM 28 rotates and positions the carriage 26. The ramp load mechanism 30 unloads the magnetic head 24 to a position at a distance from the magnetic disk 20 when the head is moved to the central portion of the disk 20. The electromagnetic latch 32 holds the carriage 26 in a retreated position. The board unit 34 has a head IC and the like.

The spindle motor 22 is mounted on the first shell 10a. The motor 22 has a spindle 36, which is fixed to and set up almost perpendicular to the inner surface of the first shell 10a. An extended end of the spindle 36 is fixed to the second shell 10b with a fixing screw 37 that is screwed into the second shell from outside. Thus, the spindle 36 is supported by the first and second shells 10a and 10b from both sides.

A bearing 40 rotatably supports a rotor 42 on the spindle 36. The second-shell-side end portion of the rotor 42 constitutes a columnar hub 43. The magnetic disk 20 is coaxially fitted on the hub 43. A clamp ring 44 is fitted on an end portion of the hub 43, thereby holding the inner peripheral edge portion of the disk 20. Thus, the disk 20 is fixed to the rotor 42 so that it can rotate integrally with the rotor.

A ring-shaped permanent magnet 46 is fixed to the first-shell-side end portion of the rotor 42 so that it is coaxial with the rotor 42. The spindle motor 22 has a stator core 47 attached to the first shell 10a and coils 48 wound around the stator core 47. The stator core 47 and the coils 48 are located outside the permanent magnet 46 with a gap between them. A ring-shaped shield plate 50 is attached to the first shell 10a. It is located between the coils 48 and the magnetic disk 20.

The carriage 26 and the VCM 28, which constitute a head actuator, the board unit 34, the electromagnetic latch 32, and the air filter 35 are attached to the second shell 10b, and constitute a subassembly 51 in conjunction with the second shell 10b. The subassembly 51 is separably combined with the first shell 10a on which the spindle motor 22 and the magnetic disk 20 are mounted.

The carriage 26 is provided with a bearing assembly 52 that is fixed on the inner surface of the second shell 10b. The bearing assembly 52 has a pivot 53 and a cylindrical hub 54. The pivot 53 is set up on the inner surface of the second shell 10b at right angles thereto. The hub 54 is rotatably supported on the pivot 53 by means of a pair of bearings. An extended end of the pivot 53 is fixed to the first shell 10a with a fixing screw 56 that is screwed into the first shell from outside. Thus, the pivot 53 is supported by the first and second shells 10a and 10b from both sides.

The carriage 26 is provided with an arm 58, a suspension 60, and a support frame 62. The arm 58 extends from the hub 54, and the suspension 60, in the form of an elongated plate, extends from the distal end of the arm. The frame 62 extends from the hub 54 in a direction opposite to the extension of the arm 58. A gimbals portion (not shown) supports the magnetic head 24 on an extended end of the suspension 60. A voice coil 64 that constitutes the VCM 28 is fixed integrally to the frame 62.

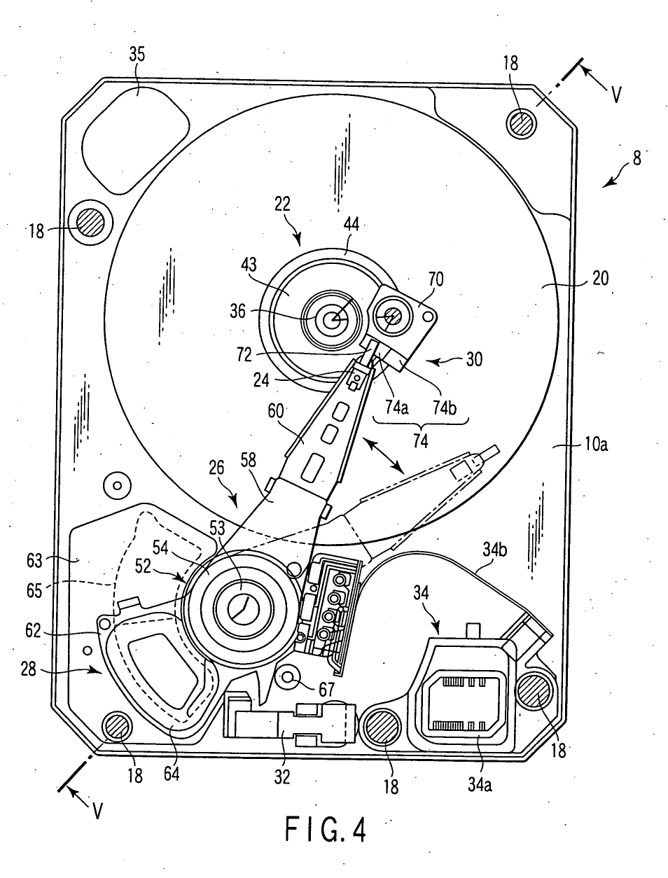

The VCM 28, which rotates the carriage 26 around the bearing assembly 52, includes a yoke 63, a magnet 65, and another yoke 66. The yoke 63 is fixed on the second shell 10b. The magnet 65 is fixed to the inner surface of the yoke 63 and opposed to the voice coil 64. The yoke 66 is opposed to the magnet 65 with the voice coil 64 between them. When the voice coil 64 is energized, the carriage 26 rotates over the magnetic disk 20 between the retreated position indicated by full line in FIG. 4 and the outer periphery of the disk. Thereupon, the magnetic head 24 is positioned on a desired track of the magnetic disk 20. A stopper pin 67 on the second shell 10b restrains the carriage 26 from excessively rocking beyond the retreated position. If the HDD is subjected to external force such as shock, the electromagnetic latch 32 that is fixed to the second shell 10b latches the carriage 26 in the shunt position, thereby preventing the carriage from moving from the retreated position to an operating position.

As shown in FIGS. 3 to 5, the ramp load mechanism 30 comprises a ramp member 70 and a tab 72. The ramp member 70 is fixed to the inner surface of the second shell 10b and opposed to the central portion of the magnetic disk 20. The tab 72 extends from the distal end of the suspension 60 and serves as an engaging member. The ramp member 70 is formed by bending a plate member and has a ramp surface 74 that can be engaged by the tab 72. The ramp surface 74 has a support surface 74a and a slanting surface 74b. The support surface 74a is opposed to the inner surface of the second shell 10b with a substantially parallel gap between them. The slanting surface 74b extends declining from the support surface toward the first shell 10a or the surface of the magnetic disk 20. When the carriage 26 rotates from the outer peripheral portion of the disk 20 to the retreated position on the inner periphery of the magnetic disk, the tab 72 engages the slanting surface 74b of the ramp member 70. Thereafter, the tab 72 is pulled up by the inclination of the ramp surface, whereupon the magnetic head 24 is unloaded. When the carriage 26 rotates to the retreated position, the tab 72 is supported on the support surface 74a of the ramp member 70, and the head 24 is kept apart from the surface of the disk 20.

The board unit 34 has a body 34a that is formed of a flexible printed circuit board. The body 34a is fixed to the inner surface of the second shell 10b. The head IC, a head amplifier, and other electronic components are mounted on the body 34a. The board unit 34 has a main flexible printed circuit board (hereinafter referred to as a main FPC) 34b that extends from the body 34a. An extended end of the main FPC 34b is connected to that part of the carriage 26 which is situated near the bearing assembly 52, and is also connected electrically to the magnetic head 24 through a cable (not shown) on the arm 58 and the suspension 60. A connector 76 (FIG. 3) to be connected to the control circuit board 12 is mounted on the bottom surface of the body 34a of the board unit 34. The connector 76 is exposed to the outer surface of the second shell 10b through an opening 77 in the second shell.

The body of the HDD is constructed in a manner such that the casing 10 is formed by combining the subassembly 51 having the aforesaid configuration with the first shell 10a. In the assembled state, the spring force of the suspension 60 subjects the magnetic head 24 to a given head load that is directed to the surface of the magnetic disk 20.

As shown in FIG. 2, the control circuit board 12 has substantially the same plane shape as that of the casing 10, and is opposed to the outer surface of the second shell 10b. In this case, the circuit board 12 is fixed to the outer surface of the shell 10b with a double-coated tape. The second-shell-side surface of the circuit board 12 carries thereon an interface with external devices, a plurality of electronic components 80 including a connector 78, and a write-protect switch 81. The connector 78 is connected electrically and mechanically to the connector 76 on the HDD body. A plurality of pad-shaped connecting terminals 82 are formed on an end portion of the outer surface of the control circuit board 12, that is, of that surface on the side opposite from the second shell 10b.

As shown in FIGS. 1 and 2, the casing 10 and the control circuit board 12 of the HDD are encapsulated in the cover 14, and form a card-shaped structure as a whole. The cover 14 has first and second plastic covers 14a and 14b in the form of a rectangular tray each. The first cover 14a covers the first shell 10a of the casing 10, while the second cover 14b covers the control circuit board 12 and the second shell 10b. The first and second covers 14a and 14b are coupled to each other with their respective peripheral edge portions fitted with each other. The second cover 14b has a plurality of openings 84 that individually face the connecting terminals 82 of the circuit board 12. The terminals 82 are exposed to the outside from the cover 14 through the openings 84 and can be connected to another electronic device.

In assembling the HDD 8 having the configuration described above, the spindle motor 22 is first attached to the first shell 10a. Then, the magnetic disk 20 is fitted on the hub of the motor 22 and fixed by means of the clamp ring 44. On the other hand, the subassembly 51 is formed by loading the second shell 10b with the carriage 26, VCM 28, ramp load mechanism 30, electromagnetic latch 32, board unit 34, and air filter 35.

Subsequently, the first and second shells 10a and 10b are adjusted in location and joined together. In this way, the respective distal ends of the support posts 18 on the second shell 10b are caused to engage their corresponding portions of the first shell 10a. The spindle 36 of the spindle motor 22 is fixed to the second shell 10b by means of the fixing screw 37. The pivot 53 of the bearing assembly 52 of the carriage 26 is fixed to the first shell 10a with the fixing screw 56. Further, the shells 10a and 10b may be screwed to each other in any other positions.

Then, the sealing belt 16 is wound around the respective peripheral edge portions of the first and second shells 10a and 10b to tie them together and close the gap between them. Thereafter, the control circuit board 12 is connected to the body of the HDD and attached to the outer surface of the second shell 10b. Subsequently, the casing 10 and the circuit board 12 are covered with the first and second covers 14a and 14b from both sides, and the covers are fitted with each other. Thereupon, the HDD 8 is completed.

According to the HDD constructed in this manner, the casing 10 includes the first and second shells 10a and 10b. The spindle motor and the magnetic disk are attached to the first shell, while the other components are attached to the second shell to form the subassembly. In other words, the spindle motor and the magnetic disk that occupy the largest area and the other components are fixed to the separate shells, and the HDD is formed by combining these shells. Thus, the components can be attached to or mounted on the first and second shells 10a and 10b individually. Even if the HDD is reduced in overall size, therefore, good spaces can be secured for setting and assembling its components. Thus, further miniaturization of the HDD can be realized.

In the present embodiment, the ramp load mechanism 30 unloads the magnetic head 24 from the surface of the magnetic disk 20 and holds it when the head is moved to the inner peripheral portion or central portion of the disk. With use of this inner peripheral ramp structure, the outer peripheral portion of the magnetic disk can be effectively used as a data recording region. When compared with the case where a ramp is located on the outer peripheral side of the magnetic disk, the recording capacity of the disk can be increased. An HDD that uses a small-sized magnetic disk, in particular, can enjoy a positive effect. According to the present embodiment, the ramp member 70 is attached to the second shell 10b, so that it can be easily located without interfering with the magnetic disk 20 or the spindle motor 22.

The first and second shells 10a and 10b that constitute the casing 10 are supported opposite each other with the given gap between them by the support posts 18 on one of them. If any external force acts on the casing 10, therefore, it can be prevented from damaging the casing and the components therein. Since the proximal end of each post 18 is fixed to the shell across the elastic member, dimensional and assembly errors between the first and second shells, as well as shock, can be absorbed. With use of the support posts 18, moreover, screwing positions between the first and second shells 10a and 10b can be reduced in number, and assemblability and maintainability can be improved.

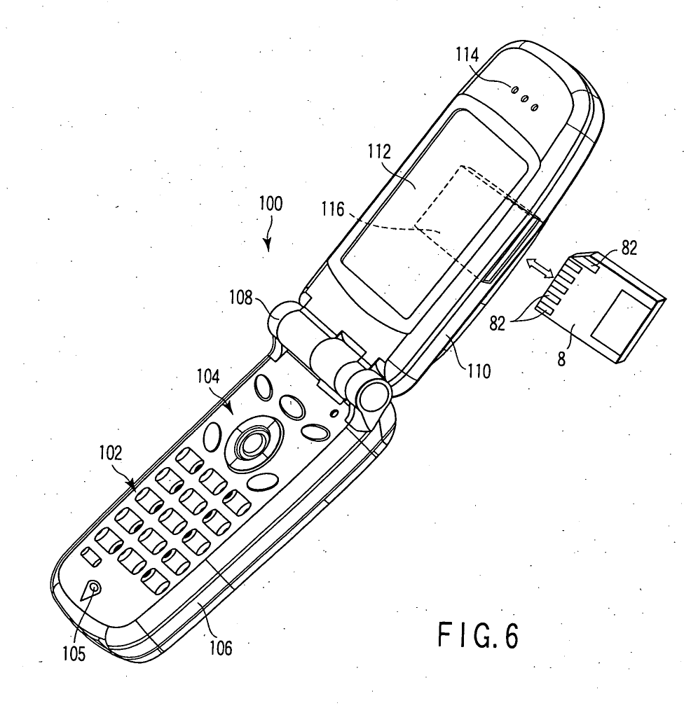

The card-shaped, portable HDD 8 constructed in this manner can be used as a recording unit for various electronic devices. For example, the HDD 8 may be used as a recording device for a cellular phone 100, as shown in FIG. 6. The cellular phone 100 comprises a body 106 and a display section 110. Dial keys 102, operating keys 104, a microphone 105, etc. are arranged on the body 106. The display section 110 is rotatably connected to the body 106 by means of a hinge section 108. The display section 110 is provided with a display panel 112, which displays transmission information, reception information, etc., a speaker 114, and the like. In the display section 110, the backside portion of the display panel 112 is formed having a storage portion 116 that removably stores the HDD 8. The HDD 8 is loaded into the storage portion 116 through a slot in a side face of the display section 110, for example, and is connected electrically to the cellular phone 100. Thus, there can be obtained the cellular phone 100 having the HDD 8 as the recording device.

The HDD 8 may be used as a recording device for various electronic devices, such as a digital camera, video camera, personal digital assistant (PDA), etc., as well as for the cellular phone.

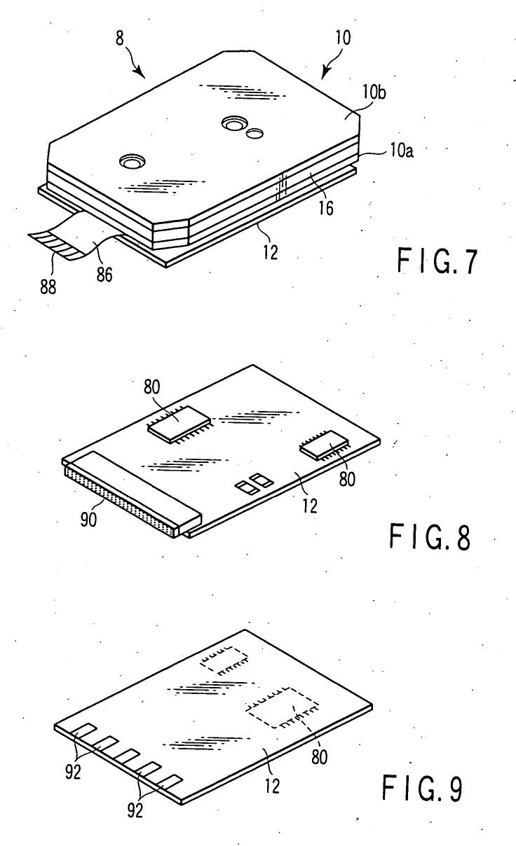

Although the card-shaped HDD that can be removably loaded into an electronic device has been described in connection with the foregoing embodiment, the invention may alternatively be applied to a stationary HDD that is contained in an electronic device. As shown in FIG. 7, an HDD 8 according to a second embodiment of the invention comprises a casing 10, which constitutes a body, and a control circuit board 12. The casing 10 has first and second shells 10a and 10b, the respective peripheral edge portions of which are joined and sealed together with the sealing material 16. Various components are located in the casing 10. The casing 10 and the components therein are arranged in the same manner as those of the first embodiment, so that a detailed description of those elements will be omitted.

The control circuit board 12 is screwed to the first shell 10a and opposed to the outer surface of the first shell. The circuit board 12 is mounted with various electronic components and is connected with a flexible printed circuit board 86 for electrically connecting the HDD 8 to an external device. The flexible printed board 86 is led out of the circuit board 12, and connecting terminals 88 are formed on its extended end. The casing 10 and the control circuit board 12 are exposed without being covered.

The HDD 8 constructed in this manner is mounted in the storage portion 116 of the cellular phone shown in FIG. 6, for example. It is fixed in the storage portion by screwing or the like and connected electrically to the phone by means of the flexible printed circuit board 86.

The same function and effect as in the first embodiment can be obtained from the HDD constructed in this manner and the electronic device provided with the same.

In the second embodiment, the control circuit board 12 may be designed so that an interface connector 90, instead of the flexible printed circuit board 86, can be mounted directly on it, as shown in FIG. 8. In this case, the HDD 8 is connected electrically to the electronic device via the interface connector 90. Alternatively, as shown in FIG. 9, a plurality of pad-shaped connecting terminals 92 may be formed directly on the control circuit board 12 so that the HDD 8 can be connected electrically to the electronic device through the terminals 92.

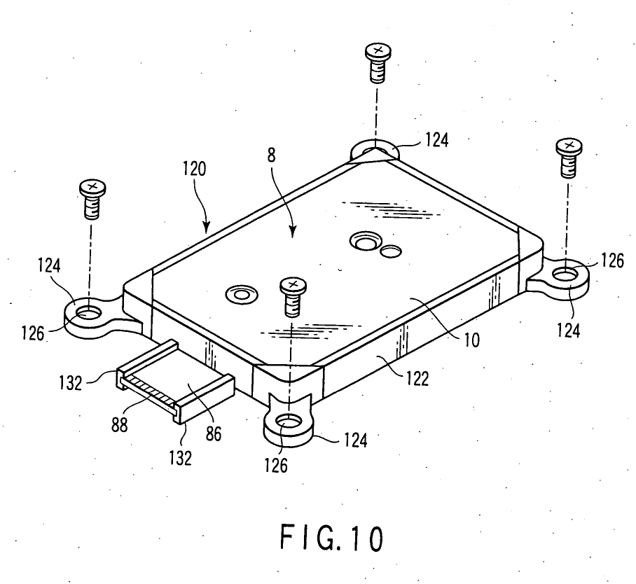

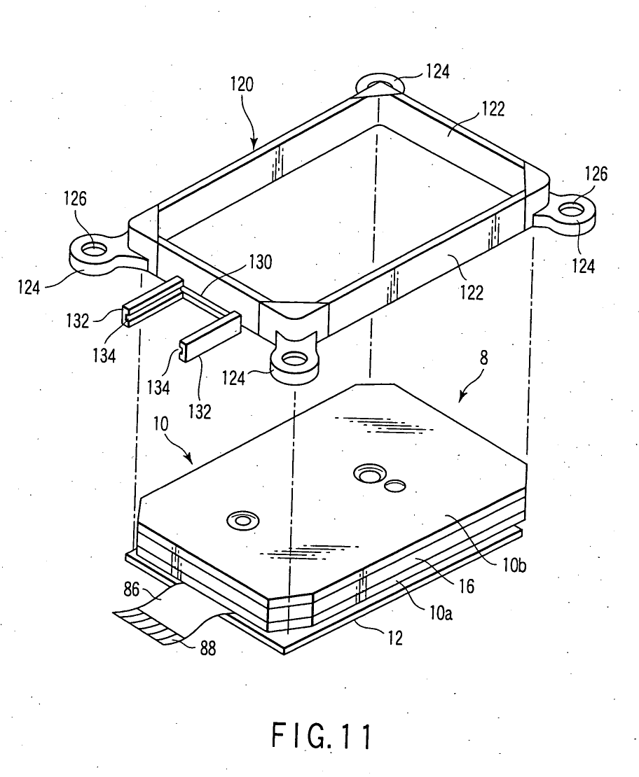

As in a third embodiment shown in FIGS. 10 and 11, a built-in HDD may be provided with a mounting aid 120 that supports its mounting on the electronic device. The mounting aid 120 has a body 122 and four brackets 124. The body 122 is a rectangular frame that is fitted on the outer peripheral portions of a casing 10 and a control circuit board 12. The brackets 124 extend individually from the corner portions of the body 122. The body 122 is formed of an elastic material such as plastics and is elastically fitted on the casing 10 and the circuit board 12. The brackets 124 are formed of metal, for example. A through hole 126 is formed in each bracket 124. A screw for attaching an HDD 8 to a mounting portion of an electronic device can be pass through the through hole 126 of each bracket 124, for example.

A slit 130 is formed in one sidewall of the body 122. A pair of retaining lugs 132 extend integrally outward from the opposite sides of the slits, individually. The lugs 132 that serve as cable supporting members extend parallel to each other, and their opposite surfaces are formed individually having support grooves 134 that extend to the slit 130. A flexible printed circuit board 86 that extends from the control circuit board 12 and forms a connecting cable is led out through the slit 130 of the body 122. The opposite side edge portions of the circuit board 86 engage the respective support grooves 134 of the retaining lugs 132. Thus, the lugs 132 hold an extended end portion of the circuit board 86 in a given position.

The HDD 8, having the mounting aid 120 fitted thereon in this manner, can be easily mounted in a desired position in the electronic device. At the same time, the extended end portion of the flexible printed circuit board 86, having connecting terminals 88 thereon, is held in the given position by the retaining lugs 132, so that it can be connected electrically to the electronic device with ease and reliability.

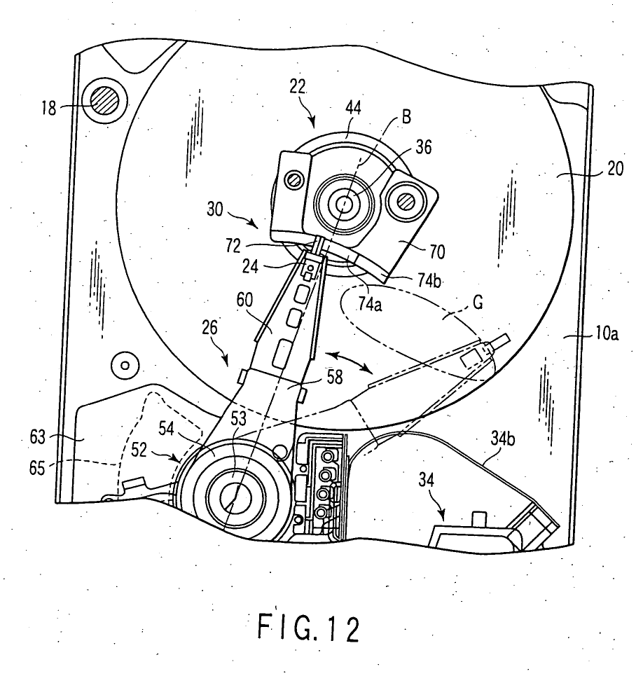

In an HDD according to a fourth embodiment of the invention shown in FIG. 12, a ramp member 70 of a ramp load mechanism 30 is opposed to the central portion of a magnetic disk 20 and attached to a second shell 10b. The ramp member 70 has a ramp surface that can be engaged by a tab 72 of a suspension 60. The ramp surface has a support surface 74a and a slanting surface 74b. The support surface 74a is opposed to the inner surface of the second shell 10b substantially in parallel thereto with a gap therebetween. The slanting surface 74b extends declining from the support surface 74a toward a first shell 10a or the surface of the magnetic disk 20. The support surface 74a extends along the path of movement of the tab 72 and astride a line B that connects a pivot 53, the center of rotation of a carriage 26, and a spindle 36, the center of the disk 20.

If the carriage 26 rotates from the outer peripheral portion of the magnetic disk 20 to a retreated position on the inner periphery of the disk, the tab 72 engages the slanting surface 74b of the ramp member 70. Thereafter, the tab 72 is pulled up by the inclination of the ramp surface, whereupon the magnetic head 24 is unloaded. Further, the carriage 26 is rotated beyond the line B to the retreated position. Thus, the tab 72 is supported on the support surface 74a of the ramp member 70, and the magnetic head 24 is kept apart from the surface of the disk 20.

According to the fourth embodiment arranged in this manner, the ramp member 70 is located in a position such that the magnetic head 24 is unloaded from the magnetic disk 20 on the side opposite from a region G, in which the head processes information on the disk 20, with respect to the line B that connects the center of the disk and the center of rotation of the carriage 26. Thus, the inner peripheral portion of the magnetic disk 20 can be also used as an information recording region, so that the recording capacity of the magnetic disk 20 can be increased further. The fourth embodiment shares other configurations with the first embodiment, so that like reference numerals are used to designate like portions, and a detailed description of those portions will be omitted.

It is to be understood that the present invention is not limited to the precise embodiments described above, and that various changes and modifications may be effected therein without departing from the scope or spirit of the invention. Further, various other inventions may be made by suitably combining the components described in connection with the foregoing embodiments. For example, some of the components according to the embodiments may be omitted. Further, the components according to different embodiments may be suitably combined as required.

Although the control circuit board is secured to the outer surface of the second shell according to the first embodiment, for example, it may alternatively be opposed to the first shell. In another embodiment, the control circuit board may have a first part connected to the outer surface of the first shell and a second part connected to the outer surface of the second shell. This latter arrangement may be suitable not only for single disk structures but for multiple disk structures. The number of magnetic disks used in the disk drive is not limited to one but may be increased as required. The ramp member of the ramp load mechanism may be located on the outer peripheral side of the magnetic disk.

1. A disk drive comprising:
a first shell and a second shell which is opposed to the first shell and constitutes a casing in conjunction with the first shell;
a drive motor located on the first shell and a disk-shaped information recording medium which is supported and rotated by the drive motor;
a head which processes information for the information recording medium;
a head actuator which is attached to the second shell, supports the head for movement, and moves the head with respect to the information recording medium; and
control circuitry for controlling said head actuator and having a first portion, attached to the second shell and connected to the head actuator and at least one second portion located on at least one of said first and second shells and connected to said first portion.

2. A disk drive according to claim 1 wherein said first portion of the control circuitry comprises a control unit attached to the second shell and enclosed within said casing and said at least one second portion of said control circuitry comprises a control circuit board secured to an outer surface of the casing and connected to the board unit.

3. A disk drive according to claim 1, which comprises a plurality of support posts set up in the casing and supporting the first and second shells, each of the support posts having one end fixed to an inner surface of one of the first and second shells across an elastic material and the other end in engagement with the other shell.

4. A disk drive according to claim 1, wherein the first and second shells individually have peripheral edge portions opposed to each other across a gap, and the casing has a sealing member which connects respective peripheral edge portions of the first and second shells and closes the gap between the peripheral edge portions.

5. A disk drive according to claim 1, wherein the drive motor has a spindle, which is set up on the first shell and has an extended end fixed to the second shell, and a rotor rotatably supported on the spindle.

6. A disk drive according to claim 1, wherein the head actuator includes a bearing portion, which is set up on the second shell and has an extended end fixed to the first shell, and a carriage, which supports the head and is rotatably supported on the bearing portion.

7. A disk drive according to claim 6, wherein the head actuator includes a voice coil motor which rotates the carriage, the voice coil motor having a voice coil attached to the carriage and a yoke and a magnet which are fixed to the second shell and opposed to the voice coil.

8. A disk drive according to claim 1, which further comprises a ramp member which is opposed to a central portion of the information recording medium in the casing and which unloads the head into a position such that the head is separated from the information recording medium when the head is moved to the central portion of the information recording medium.

9. A disk drive according to claim 8, wherein the ramp member is attached to the second shell.

10. A disk drive according to claim 8, wherein the head actuator includes a rotatable carriage which supports the head for movement between the central portion and an outer peripheral portion of the information recording medium, and the ramp member is located in a position such that the head is unloaded from the information recording medium on the side opposite from a region in which the head processes information on the disk with respect to a line which connects respective centers of rotation of the information recording medium and the carriage.

11. A disk drive according to claim 2, which further comprises a cover which encloses the casing and the control circuit board, and wherein the control circuit board has a connecting terminal extending through said cover to a region outside of said cover.

12. A disk drive according to claim 11, wherein the control circuit board is secured to an outer surface of the second shell.

13. A disk drive according to claim 2, wherein the control circuit board has a connecting terminal exposed in an outer surface thereof.

14. A disk drive according to claim 13, wherein the control circuit board is secured to an outer surface of the first shell.

15. A disk drive according to claim 2, wherein the control circuit board has a connecting terminal connectable to an external device.

16. A disk drive according to claim 15, wherein the control circuit board is secured to an outer surface of the first shell.

17. A disk drive according to claim 2, which further comprises a mounting aid attached to the casing, the mounting aid having a frame-shaped body fitted on an outer peripheral portion of the casing and a plurality of brackets extending from the body and each having a through hole through which a mounting screw can be passed.

18. A disk drive according to claim 17, which further comprises a connecting cable extending from the control circuit board and having a connecting terminal, and the mounting aid has a cable supporting portion which supports the connecting cable with the connecting terminal exposed.

19. An electronic device comprising:
a device body; and
the disk drive according to claim 1 located in the device body.

20. An electronic device comprising:
a device body having a storage portion; and
the disk drive according to claim 11 removably set in the storage portion and connected to the device body through the connecting terminal.

21. A disk drive comprising:
a first shell and a second shell which is opposed to the first shell and constitutes a casing in conjunction with the first shell,
a drive motor located within the casing and a disk-shaped information recording medium which is supported and rotated by the drive motor;
a head which processes information for the information recording medium;
a head actuator located within the casing and supporting the head for movement with respect to the information recording medium;
control circuitry for controlling said head actuator and having a first portion enclosed within said casing and connected to the head actuator and at least one second portion located on an outer surface of at least one of said first and second shells and connected to said first portion; and
a flexible printed circuit board connected to said at least one second portion and having connecting terminals at a distal end thereof for connection to an external device.

22. A disk drive according to claim 21 further comprising at least one support member for supporting said flexible printed circuit board.

23. A disk drive according to claim 21,
wherein said head actuator has a bearing assembly with a pivot member,
said disk drive further comprises:
a bearing mechanism including a spindle for supporting rotation of said information recording medium, and
a first fixing screw attached to one of said first and second shells and secured to one of said pivot member and said spindle.

24. A disk drive according to claim 23 wherein said disk drive further comprises a second fixing screw attached to one of said first and second shells and secured to the other of said pivot member and said spindle.
